(19) United States
(12) Patent Application Publication
(10) Pub. No.: US 2016/0062939 A1
(43) Pub. Date: Mar. 3, 2016

(54) CONNECTOR WITH IN-CIRCUIT PROGRAMMING

(71) Applicant: AirBorn, Inc., Georgetown, TX (US)

(72) Inventors: Jason Smith, Sartell, MN (US); Greg Parkhurst, Brooklyn Park, MN (US)

(21) Appl. No.: 14/474,170

(22) Filed: Aug. 31, 2014

(51) Int. Cl. G06F 13/40; G06F 13/42; H01R 13/66

(52) U.S. Cl. CPC G06F 13/4068; H01R 13/665; G06F 13/409; G06F 13/4221

(57) ABSTRACT

Method and apparatus are provided for performing in-circuit serial programming of microcontrollers embedded within the connectors of smart cables. The method and apparatus involve providing a connector for the smart cables wherein the serial programming pins of the microcontroller are brought out or otherwise electrically connected to the sockets or pins of the connector. These sockets or pins may then be used to program the microcontroller directly from the smart cable using substantially the same programming protocols that are used with socket programmers and in-circuit programmers, but without requiring a socket programmer or an in-circuit programmer.

### FIELD OF THE INVENTION

The disclosed embodiments relate generally to programmable connectors used in so-called “smart cables” and particularly to a connector for a smart cable that provides in-circuit serial programming of the connector using the pins of the connector itself.

### BACKGROUND OF THE INVENTION

Smart cables refer to cables that can store and provide information about the cables to the devices to which the cables are connected. Typically, the connector portion of these smart cables have an embedded microcontroller that can transmit information about the cables over the connector pins to the devices. Such information may include, for example, whether the cable is an authorized cable (i.e., authentication information), what type of cable (i.e., identification information), what type of signal it can carry (i.e., signal information), and so forth.

The information provided by the cables is typically stored in non-volatile memory within the connector. The non-volatile memory may be a separate component from the microcontroller in some cases, or it may be integrated with the microcontroller in some cases. In either case, the microcontroller can access the non-volatile memory as needed and retrieve the information, then communicate the information to the devices to which the cable is connected. The microcontroller may also be used to update or modify the information in the non-volatile memory as needed.

One type of microcontroller often used with smart cable connectors is a PIC microcontroller, examples of which are available from Microchip Technology Inc., of Chandler, Ariz. The PIC series of microcontrollers are popular in many applications owing to their low cost, wide availability, large user base, extensive collection of application notes, and availability of low-cost or even free development tools. Another feature of PIC microcontrollers is their serial programming and re-programming capability, which makes it possible and convenient to modify and update the programs on the microcontrollers.

Programming any microcontroller generally entails downloading and storing a program onto the microcontroller by copying the program, typically from a HEX file, into a designated memory of the microcontroller. Typically, a computer and a piece of hardware called a “programmer” are used to program the microcontroller. The programmer connects the computer to certain designated serial programming pins on the microcontroller to allow the computer to transmit a program serially to the microcontroller. A number of such programmers are commercially available from various vendors.

One commercially available programmer uses a socket to connect the serial programming pins of the microcontroller to the computer, typically through a parallel port, a serial port (COM port), or a USB port of the computer. These socket programmers require the microcontroller to be placed within the socket in order to program the microcontroller. As such, socket programmers may only be used to program microcontrollers before they are mounted on printed circuit boards or otherwise installed in their intended applications.

An in-circuit programmer, on the other hand, uses flexible lead wires instead of a socket. The flexible lead wires may be attached to the programming pins or contacts of the microcontroller while it is mounted on a printed circuit board. This allows the microcontroller to be programmed in the printed circuit board or in the intended application. But as the size of microcontrollers (and their applications) continue to decrease, it becomes increasingly difficult to attach the lead wires to the microcontroller pins or contacts.

Accordingly, a need exists for an improved method and apparatus for performing in-circuit serial programming of microcontrollers and, more particularly, microcontrollers that are embedded within smart cable connectors.

### SUMMARY OF THE DISCLOSED EMBODIMENTS

The disclosed embodiments provide an improved method and apparatus for performing in-circuit serial programming of microcontrollers that are embedded within the connectors of smart cables. The embodiments involve providing a connector for the smart cables wherein the serial programming pins of the microcontroller are brought out or otherwise electrically connected to the sockets or pins of the connector. These sockets or pins of the connectors may be dedicated sockets or pins that are connected only to the programming pins of the microcontroller, or one or more sockets or pins of the connectors may be electrically connected to both the programming pins of the microcontroller and the wires of the cable. The sockets or pins may then be used to program the microcontroller directly from the smart cable using substantially the same programming protocols that are used with socket programmers and in-circuit programmers, but without requiring a socket programmer or an in-circuit programmer.

In general, in one aspect, the disclosed embodiments are directed to a connector assembly. The connector assembly comprises a connector portion, a housing portion attached to and extending from the connector portion, and a printed circuit board disposed within the housing portion. The printed circuit board includes a plurality of conductive contact pads and a plurality of conductive mounting pads formed thereon, each mounting pad being electrically connected to at least one of the contact pads. The smart cable further comprises a microcontroller mounted on the printed circuit board, the microcontroller having a plurality of conductive contacts electrically connected to the mounting pads of the printed circuit board. The conductive contacts include programming contacts that are required for programming of the microcontroller. A plurality of conductive leads are disposed within the housing portion, each lead having a first end extending into the connector portion and a second end electrically connected to one of the contact pads such that each programming contact of the microcontroller is electrically connected to at least one lead.

In general, in another aspect, the disclosed embodiments are directed to a smart cable. The smart cable comprises a housing portion, a cable having a plurality of wires therein extending into the housing portion, and a printed circuit board disposed within the housing portion, the printed circuit board including a plurality of conductive contact pads and a plurality of conductive mounting pads formed thereon, each mounting pad being electrically connected to at least one of the contact pads. The smart cable further comprises a microcontroller mounted on the printed circuit board, the microcontroller having a plurality of conductive contacts electrically connected to the mounting pads of the printed circuit board. The conductive contacts includes serial programming contacts that are required for serial programming of the microcontroller. A connector portion is attached to and extends from the housing portion, and a plurality of conductive leads are disposed within the housing portion. Each lead has a first end extending into the connector portion and a second end electrically connected to one of the contact pads such that each serial programming contact of the microcontroller is electrically connected to at least one lead.

In general, in still another aspect, the disclosed embodiments are directed to a method of in-circuit serial programming a microcontroller. The method comprises plugging a smart cable into an external device, the smart cable having the microcontroller embedded in a connector assembly of the smart cable, and performing serial programming of the microcontroller through one or more pins of the smart cable using the external device. The connector assembly comprises a connector portion having a plurality of pins therein, a housing portion attached to and extending from the connector portion, and a printed circuit board disposed within the housing portion. The printed circuit board includes a plurality of conductive contact pads and a plurality of conductive mounting pads formed thereon, each mounting pad being electrically connected to at least one of the contact pads. A microcontroller is mounted on the printed circuit board, the microcontroller having a plurality of conductive contacts electrically connected to the mounting pads of the printed circuit board. The conductive contacts include serial programming contacts that are required for serial programming of the microcontroller, the serial programming contacts being electrically connected to at least one of the contact pads.

### BRIEF DESCRIPTION OF THE DRAWINGS

The foregoing and other advantages of the disclosed embodiments will become apparent upon reading the following detailed description and upon reference to the drawings, wherein:

FIG. 1 is a perspective view of an exemplary smart cable connector according to some implementations of the disclosed embodiments;

FIG. 2 is an exploded view showing the various components of the smart cable connector according to some implementations of the disclosed embodiments;

FIG. 3 is a close up view of a printed circuit board and microcontroller for the connector according to some implementations of the disclosed embodiments;

FIG. 4 is an exemplary pinout diagram of the microcontroller for the connector according to some implementations of the disclosed embodiments;

FIG. 5 is an exemplary circuit diagram for the microcontroller and the connector according to some implementations of the disclosed embodiments.

### DETAILED DESCRIPTION OF THE DISCLOSED EMBODIMENTS

As an initial matter, it will be appreciated that the development of an actual, real commercial application incorporating aspects of the disclosed embodiments will require many implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

As well, it should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

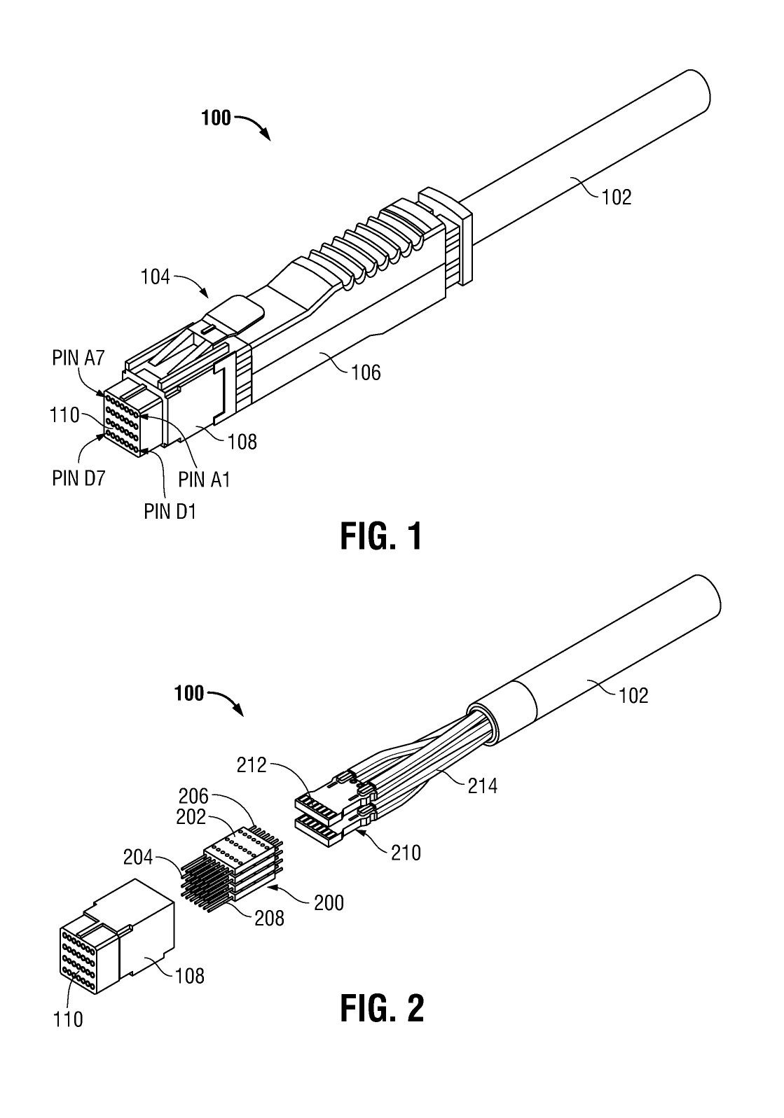

Referring now to FIG. 1, a smart cable that may be used in accordance with the method and apparatus disclosed herein is shown. The particular smart cable shown is a specific type of smart cable often used to transmit high speed data between low profile PCI Express® (PCIe) add-in cards. It will be understood, however, that the method and apparatus disclosed herein are not limited to the particular smart cable shown, or PCIe cables in general, but are equally applicable to any type of cable employing a programmable microcontroller embedded in the connector.

As FIG. 1 shows, the smart cable 100 is made of several components, including a cable 102 containing a plurality of wires (not expressly shown here) and a connector assembly 104 composed of a housing portion 106 and a connector portion 108 physically attached to and extending from the housing portion 106. In this example, the connector portion 108 is a male connector portion 108 typically made of an insulating plastic material and having a plurality of cylindrical cavities 110 that are arranged in rows and columns. Specifically, there may be four rows, Rows A, B, C, and D going from top to bottom, and seven columns, Columns 1, 2, 3, 4, 5, 6, and 7 going from right to left for a total of 28 pins. A female version of the connector portion 108 may have a similar arrangement except socket contacts would be present in place of the cylindrical cavities 110.

In the above example, the first socket or pin, Pin A1, may be in the upper right-hand corner of the connector portion 108, while the last socket or pin, Pin D7, may be in the lower left-hand corner of the connector portion 108. Additional details of the connector portion 108, such as a latch assembly, connector guides, and the like, may be found in U.S. Published Application No. 20130122745, entitled “Low-Profile Right-Angle Electrical Connector Assembly,” which is incorporated herein by reference in its entirety. As well, the method and apparatus disclosed herein may also be used with other types of smart cables that do not contain typical insulated pin and socket contacts. Such smart cables may instead include a connector with a circuit board having conductive pads that are contacted directly by a mating connector.

Within the connector portion 108, each socket or pin, as the case may be, is electrically connected to a specific wire in the cable 102 for carrying a specific signal over that wire. An example involving pin contacts is illustrated in FIG. 2, where the smart cable 100 is shown without the housing portion 106 for easier viewing of the internal components of the connector assembly 104. As can be seen, the connector assembly 104 includes a contact portion 200 composed of a plurality of planar wafers 202, each wafer 202 having a plurality of electrically conductive pin contacts 204 protruding from one end and an equal number of printed circuit board (PCB) contacts 206 protruding from the opposite end. The pin contacts 204 are sized to fit within the cylindrical cavities 110 of the connector portion 108 when the connector assembly 104 is fully assembled and are designed to electrically engage with corresponding socket contacts in a PCIe card. Similarly, the PCB contacts 206 are designed to electrically engage with a PCB 210 when the connector assembly 104 is fully assembled.

In the present example, there are four wafers 202 stacked on top of each other, each wafer 202 having seven pin contacts 204 and seven PCB contacts 206. Each socket contact 204 and corresponding PCB contact 206 form a lead 208 for a total of 28 leads. Adjacent leads 208 are evenly spaced apart from one another in the horizontal direction and in the vertical direction, although horizontal spacing and vertical spacing are not necessarily equal. As well, it should be understood that a connector assembly 104 having a different number of leads 208 from the number of leads shown here may also be used without departing from the scope of the disclosed embodiments.

The PCB contacts 206 are configured so that they may be soldered or otherwise electrically connected to one or more of the PCBs 210 within the connector assembly 104. In the present example, there are two PCBs 210 in the connector assembly 104, each PCB 210 having a plurality of conductive contact pads 212 for receiving the PCB contacts 206. Specifically, each PCB 210 may have 14 contact pads 212, seven of which are on the top side and seven of which are on the bottom side (not expressly shown) of the PCB 210, thereby allowing each PCB 210 to accommodate two wafers 202.

In a similar manner, each PCB 210 may have a plurality of wire contacts (not specifically enumerated), each wire contact configured to receive a wire 214 of the cable 102. For the present example, instead of a single wire, each wire 214 of the cable 102 may be a Twinaxial cable, or “Twinax,” that has two discrete insulated wires surrounded by an electrically conductive shield. Preformed conductive traces or paths (not visible here) in or on the PCBs 210 electrically connect the contact pads 212 to the corresponding wire contacts. Each Twinax 214 of the cable 102 may then be soldered or otherwise electrically connected to a wire contact to provide an electrical connection between that Twinax 214 and a corresponding pin contact 204 of the connector portion 200.

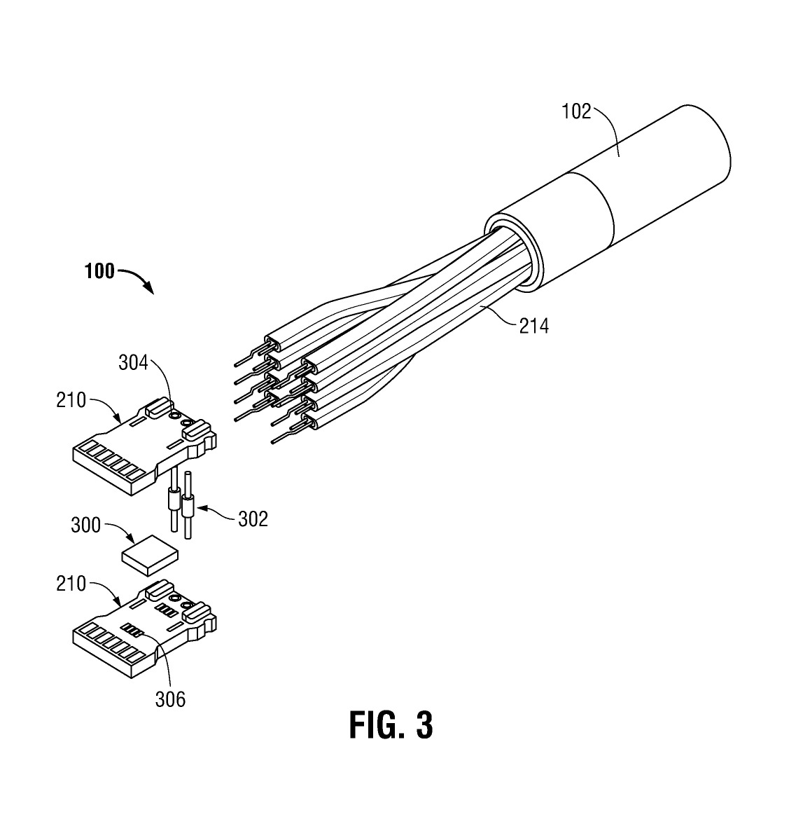

A close-up view of the PCBs 210 is shown in FIG. 3, where a microcontroller 300 can be seen that provides the “smart cable” functionality described above for the smart cable 100. Either of the PCBs 210 may hold the microcontroller 300 depending on the requirements of the specific implementation, but in the example of FIG. 3, the microcontroller 300 is to be mounted on the second (lower) PCB. One or more conductive posts 302 electrically connect the upper and lower PCBs 210 to one another through one or more vias 304 in the PCBs 210.

As implicitly shown in FIG. 3, the pins or other conductive contacts of the microcontroller 300 may be soldered or otherwise electrically connected to conductive mounting pads 306 on the PCBs 210. Preformed conductive traces or paths (not visible here) on the PCBs 210 then connect the mounting pads 306, and hence the pins or other conductive contacts of the microcontroller 300, to preselected contact pads 212 on the PCB. The contact pads 212 on the PCB 210, in turn, connect the pins of the microcontroller 300 to specific PCB contacts 206 of the wafers 202, and hence to specific pin contacts 204. In this way, certain pin contacts 204 in the cylindrical cavities 110 of the smart cable 100 may be connected via the conductive traces or paths to certain pins or other conductive contacts of the microcontroller 300. It is also possible in some embodiments for the conductive traces or paths on the PCBs 210 to provide one or more pin contacts 204 with dual connection both to selected pins of the microcontroller 300 and selected Twinax 214 of the cable 102.

The specific signals carried by the pins 110 of the smart cable 100 are typically defined according to industry standards, such as the PCI Express® Card Electromechanical Specification. According to such industry standards, certain pins are used for carrying signals while other pins may be used for ground and some pins may be left unassigned. Table 1 below identifies exemplary pin assignments that may be used for the smart cable 100 according some implementations of the disclosed embodiments.

TABLE 1

| | COLUMN | | | | | | |
|---|---|---|---|---|---|---|---|
| ROW | 1 | 2 | 3 | 4 | 5 | 6 | 7 |
| A | VCC | TX1p | TX1n | Gnd | TX3p | TX3n | SCL |
| B | Gnd | TX2p | TX2n | Gnd | TX4p | TX4n | Gnd |
| C | SS | RX2p | RX2n | Gnd | RX4p | RX4n | SDA |
| D | Gnd | RX1p | RX1n | Gnd | RX3p | RX3n | Gnd |

As can be seen in Table 1, the pins of columns 2, 3, 5, and 6 are used for data transmission and reception and have been generally designated TX and RX, while the pins of columns 1, 4, and 7 are intended for connection to the cable ground shield and have been generally designated Gnd.

In accordance with the disclosed embodiments, one or more pins of the smart cable 100 may be repurposed, or may have a dual purpose, for use with in-circuit serial programming of the microcontroller 300. In the present example, some of the ground pins in columns 1 and 7 have been repurposed for use with the programming pins of the microcontroller 300. Specifically, Pin A1 is assigned to the microcontroller voltage supply pin (VCC), Pin C1 is assigned to the microcontroller Slave Select pin (SS), Pin A7 is assigned to the microcontroller Serial Clock pin (SCL), and Pin C7 is assigned to the microcontroller Serial Data pin (SDA). These pins may then be used to program, reprogram, and otherwise communicate with the microcontroller 300 from an external device connected to the smart cable 100 according to the microcontroller's protocol.

Note that while only the pins from column 1 and 7 are used in the example of Table 1 for programming the microcontroller 300, the pins from other columns may also be used as needed, including one or more pins from column 4, without departing from the scope of the disclosed embodiments.

In general operation, the connector assembly 104, or to be more precise, the microcontroller 300 embedded in the connector assembly 104, is programmed to retrieve and transmit information about the smart cable 100 over the designated pin contacts 204 in the cylindrical cavities 110 to the external devices to which the smart cable 100 is connected. Such information is typically stored in non-volatile memory and may include, for example, whether the smart cable 100 is an authorized cable (i.e., authentication information), what type of cable (i.e., identification information), what type of signal it can carry (i.e., signal information), and so forth. The external devices may also program and reprogram the microcontroller 300 in the connector assembly 104 over the microcontroller pins that are connected or otherwise brought out to the pin contacts 204 in the cylindrical cavities 110. This allows the microcontroller 300 to be programmed directly from the smart cable 100 using substantially the same programming protocols that are used with socket programmers and in-circuit programmers, but without requiring a socket programmer or in-circuit programmer.

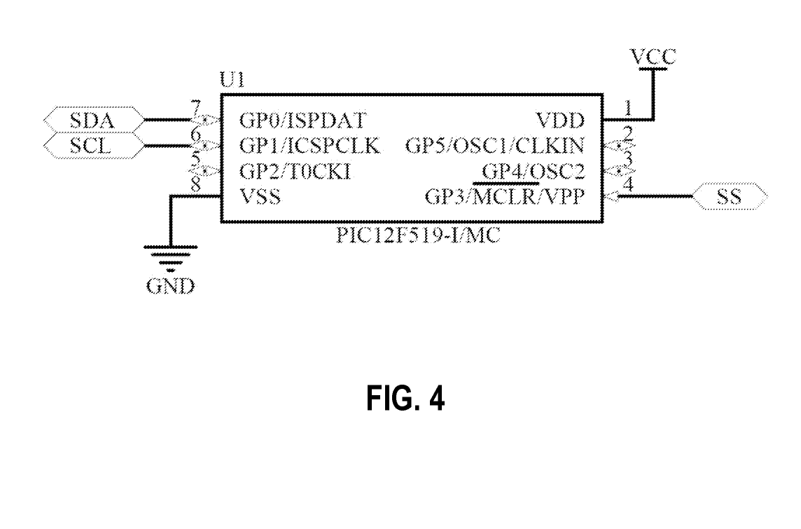

FIG. 4 shows a pinout of an exemplary microcontroller 300, specifically a PIC12F519 microcontroller from Microchip Technology, Inc., that may be used with a smart cable like the smart cable 100 discussed herein. The particular pins or other conductive contacts that are used for programming this microcontroller include Pin 1 (VDD), Pin 4 (GP3/ M̅C̅L̅R̅/VPP), Pin 6 (GP1/ICSPCLK), and Pin 7 (GP0/ISPDAT) of the microcontroller. Therefore, in accordance with the principles and teachings disclosed herein, Pins 1, 4, 6, and 7 of the microcontroller may be brought out, for example, to pins A1, C1, A7, and C7, respectively, of the smart cable 100.

Note that although a particular pinout is shown in FIG. 4, the pins used for serial programming may vary from vendor to vendor and from microcontroller to microcontroller, and therefore it will be understood that other pins besides the ones highlighted in FIG. 4 may be brought out or otherwise connected to the selected pins of the smart cable 100 without departing from the scope of the disclosed embodiments.

As well, although the generic term “pin” has been used herein, the principles and teachings discussed above are equally applicable to other types of conductive contacts, including contacts commonly used with ball grid array (BGA) packages, surface mounts packages, through-holes packages, chip carriers, and other types of integrated circuit packages, without departing from the scope of the disclosed embodiments.

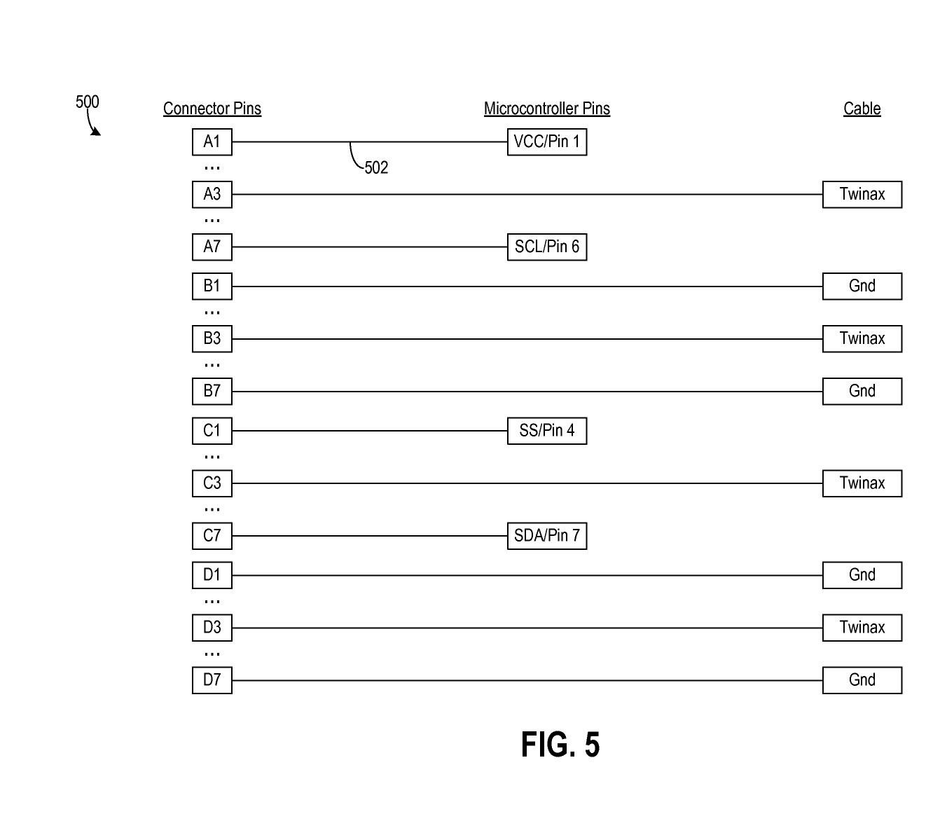

FIG. 5 is a partial exemplary circuit diagram 500 showing some of the electrical connections between the microcontroller of FIG. 4 and the smart cable 100 according to the disclosed embodiments. In this regard, the circuit diagram 500 may also reflect the conductive traces or paths on the PCBs 210 discussed with respect to FIG. 3. As lines 502 show, Pins A1 and A7 of the smart cable 100 are connected to the VCC and SCL pins of the microcontroller and Pins C1 and C7 of the smart cable 100 are connected to the SS and SDA pins of the microcontroller, while Pins B1 through B7 and D1 through D7 of the smart cable are connected to the Twinax signal conductors of the cable and to the Twinax cable ground shield.

While particular aspects, implementations, and applications of the disclosed embodiments have been illustrated and described, it is to be understood that the disclosed embodiments are not limited to the precise construction and compositions disclosed herein. For example, although the disclosed embodiments have been described with respect to in-circuit serial programming of a connector, the method and apparatus discussed herein are equally applicable to in-circuit parallel programming of a connector. Accordingly, various modifications, changes, and variations will be apparent from the foregoing descriptions without departing from the spirit and scope of the disclosed embodiments as defined in the appended claims.

What is claimed is:

1. A connector assembly, comprising:
a connector portion;
a housing portion attached to and extending from the connector portion;
a printed circuit board disposed within the housing portion, the printed circuit board including a plurality of conductive contact pads and a plurality of conductive mounting pads formed thereon, each mounting pad being electrically connected to at least one of the contact pads;
a microcontroller mounted on the printed circuit board, the microcontroller having a plurality of conductive contacts electrically connected to the mounting pads of the printed circuit board, the conductive contacts including programming contacts that are required for programming of the microcontroller; and
a plurality of conductive leads disposed within the housing portion, each lead having a first end extending into the connector portion and a second end electrically connected to one of the contact pads such that each programming contact of the microcontroller is electrically connected to at least one lead.

2. The connector assembly of claim 1, wherein the connector portion is a female connector portion and the first end of each lead is a socket contact.

3. The connector assembly of claim 1, wherein the connector portion is a male connector portion and the first end of each lead is a pin contact.

4. The connector assembly of claim 1, further comprising a plurality of wafers disposed within the housing portion, the wafers being stacked on top of each other and each wafer holding a predefined number of leads.

5. The connector assembly of claim 1, wherein the leads are arranged in four rows and seven columns for a total of 28 leads.

6. The connector assembly of claim 5, wherein the printed circuit board is a first printed circuit board, further comprising a second printed circuit board disposed within the housing adjacent to the first printed circuit board, each printed circuit board having seven conductive contacts on a topside and seven conductive contacts on a bottom side for electrically connecting the 28 leads.

7. A smart cable, comprising:
a housing portion;
a cable having a plurality of wires therein, the wires extending into the housing portion;
a printed circuit board disposed within the housing portion, the printed circuit board including a plurality of conductive contact pads and a plurality of conductive mounting pads formed thereon, each mounting pad being electrically connected to at least one of the contact pads;
a microcontroller mounted on the printed circuit board, the microcontroller having a plurality of conductive contacts electrically connected to the mounting pads of the printed circuit board, the conductive contacts including serial programming contacts that are required for serial programming of the microcontroller;
a connector portion attached to and extending from the housing portion; and
a plurality of conductive leads disposed within the housing portion, each lead having a first end extending into the connector portion and a second end electrically connected to one of the contact pads such that each serial programming contact of the microcontroller is electrically connected to at least one lead.

8. The smart cable of claim 7, wherein the microcontroller is programmed to provide information regarding the cable to an external device over the leads, the information including cable authentication information, cable identification information, and cable signal information.

9. The smart cable of claim 8, further comprising non-volatile memory mounted on the circuit board and connected to the microcontroller, wherein the information regarding the cable is stored in the non-volatile memory.

10. The smart cable of claim 7, wherein the microcontroller is a PIC microcontroller.

11. The smart cable of claim 7, wherein the smart cable is a PCIe smart cable.

12. The smart cable of claim 7, wherein the connector portion is a female connector portion and the first end of each lead is a socket contact.

13. The smart cable of claim 7, wherein the connector portion is a male connector portion and the first end of each lead is a pin contact.

14. The smart cable of claim 7, further comprising a plurality of wafers disposed within the housing portion, the wafers being stacked on top of each other and each wafer holding a predefined number of leads.

15. The smart cable of claim 7, wherein the leads are arranged in four rows and seven columns for a total of 28 leads.

16. A method of in-circuit serial programming a microcontroller, comprising:
plugging a smart cable into an external device, the smart cable having the microcontroller embedded in a connector assembly of the smart cable; and
performing serial programming of the microcontroller through one or more pins of the smart cable using the external device;
wherein the connector assembly comprises a connector portion having a plurality of pins therein, a housing portion attached to and extending from the connector portion, and a printed circuit board disposed within the housing portion, the printed circuit board including a plurality of conductive contact pads and a plurality of conductive mounting pads formed thereon, each mounting pad being electrically connected to at least one of the contact pads; and
wherein the microcontroller is mounted on the printed circuit board, the microcontroller having a plurality of conductive contacts electrically connected to the mounting pads of the printed circuit board, the conductive contacts including serial programming contacts that are required for serial programming of the microcontroller, the serial programming contacts being electrically connected to at least one of the contact pads.

17. The method of claim 16, wherein serial programming of the microcontroller comprises copying a program from a HEX file into a designated memory of the microcontroller through the connector assembly of the smart cable using the external device.
